(19) United States
(12) Patent Application Publication
(10) Pub. No.: US 2025/0144910 A1
(43) Pub. Date: May 8, 2025

(54) STRAND SIDING WITH PEBBLED STUCCO TEXTURE

(71) Applicant: LOUISIANA-PACIFIC CORPORATION, NASHVILLE, TN (US)

(72) Inventor: DAVID STACKHOUSE, NORTH WILKSBORO, NC (US)

(21) Appl. No.: 18/940,642

(22) Filed: Nov. 7, 2024

Related U.S. Application Data
(60) Provisional application No. 63/547,553, filed on Nov. 7, 2023.
(60) Provisional application No. 63/638,493, filed on Apr. 25, 2024.
(60) Provisional application No. 63/644,774, filed on May 9, 2024.

(51) Int. Cl. B32B 3/30; B32B 21/02; B32B 21/04; B32B 21/06

(52) U.S. Cl. CPC B32B 3/30; B32B 21/02; B32B 21/042; B32B 21/06; B32B 2607/00

(57) ABSTRACT

An apparatus and method of producing strand siding boards and/or panels with an irregular, pebbled stucco texture. A multi-layer mat of wood strands is formed on a production line, and a paper overlay is applied to the upper surface of the mat. The mat is then subjected to heat and pressure in a press to consolidate the mat into a board. The press comprises one or more engraved or cast metal top plates, which have been engraved or cast with a stucco impression. The stucco texture also wholly or partially eliminates telegraphing of the underlying strands and flakes in the base manufactured-wood panel.

This application claims benefit of and priority to U.S. Provisional App. No. 63/547,553, filed Nov. 7, 2023, U.S. Provisional App. No. 63/638,493, filed Apr. 25, 2024, U.S. Provisional App. No. 63/644,774, filed May 9, 2024, all of which are incorporated herein by specific reference in their entireties for all purposes.

### FIELD OF INVENTION

This invention relates to an engineered-wood strand-based siding board or panel with pebbled stucco texture.

### BACKGROUND OF INVENTION

Building wall and roof assemblies are typically layers of several materials, each performing a single function, that are installed separately on the site in which the building is being constructed. Compatibility between the various layers creates challenges not only for the designer, but also for the installers.

A typical layer in most such assembles in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include fire retardants, insect repellants, moisture resistance, fungus resistance, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability, and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above described type are produced with bending, tensile strengths and face strengths comparable to those of commercial softwood plywood.

Prior art strand-based siding provides two types of textures on the outer face: cedar woodgrain texture, and brushed smooth texture. These textures are applied by means of a metal plate used during the pressing operation to produce the siding. However, other textures have proven difficult to provide, due to the nature of the siding material, the type of texture desired, and limitations of the engraved metal plate.

### SUMMARY OF THE INVENTION

In various exemplary embodiments, the present invention comprises an apparatus and method of producing strand siding boards and/or panels with a pebbled stucco texture. Traditional stucco siding is a cement-type mixture made of Portland cement, lime, sand, and water, is applied as a thing finish coat on the outer layer of residential and commercial buildings and structures. While popular in many areas, it generally is installed in layers and requires a more professional application, making it time-consuming and expensive. The present invention thus provides engineered-wood siding panel, which can be a structural panel, with the aesthetic appearance of traditional stucco. This avoids the time and cost of traditional stucco siding.

In a method in accordance with an exemplary embodiment of the present invention, a multi-layer mat of wood strands is formed on a production line. The strands are mixed or blended with a combination of one or more resins, waxes, and/or functional additives or chemicals (e.g., pesticides, fire-resistant chemicals, and the like). A fines layer may or may not be applied to the upper surface of the mat. A paper overlay is applied to the upper surface of the mat (over the fines layer, if present). The mat is then subjected to heat and pressure in a press (which may be a multi-layer press) to consolidate the mat into a board. The press comprises one or more engraved or cast metal top plates, which have been engraved or cast with a stucco impression.

A stucco impression may be initiated from a digital scan of one or more actual stucco siding examples. The digital scan information may be combined and/or modified, such as increasing the scale (the underlying texture of the engineered wood strands and flakes will show through with small scale texture) and/or depth of the stucco features (to increase scale and visibility of the stucco texture).

After pressing, the resulting blank or board is subject to further processing, including, but not limited to, cutting into several boards or panels, sealing of edges, painting, and the like.

Accordingly, the present invention provides a structural panel with a highly-desired stucco texture with superior durability that is lightweight and easier to install than traditional stucco. Surprisingly, the stucco texture also has been found to wholly or partially eliminate telegraphing of the underlying strands and flakes in the base manufactured-wood panel. Certain textures have been developed that completely eliminate telegraphing on the surface of the panel, thereby solving a long existing problem in the manufactured wood industry.

### BRIEF DESCRIPTION OF THE DRAWINGS

FIG. 1 shows a top view of example of irregular pebbled stucco texture for strand siding panels in accordance with the present invention.

FIG. 2 shows a cutaway view of a portion of an acid-engraved plate with a portion of irregular pebbled stucco texture, above an unpressed strand mat with paper overlay.

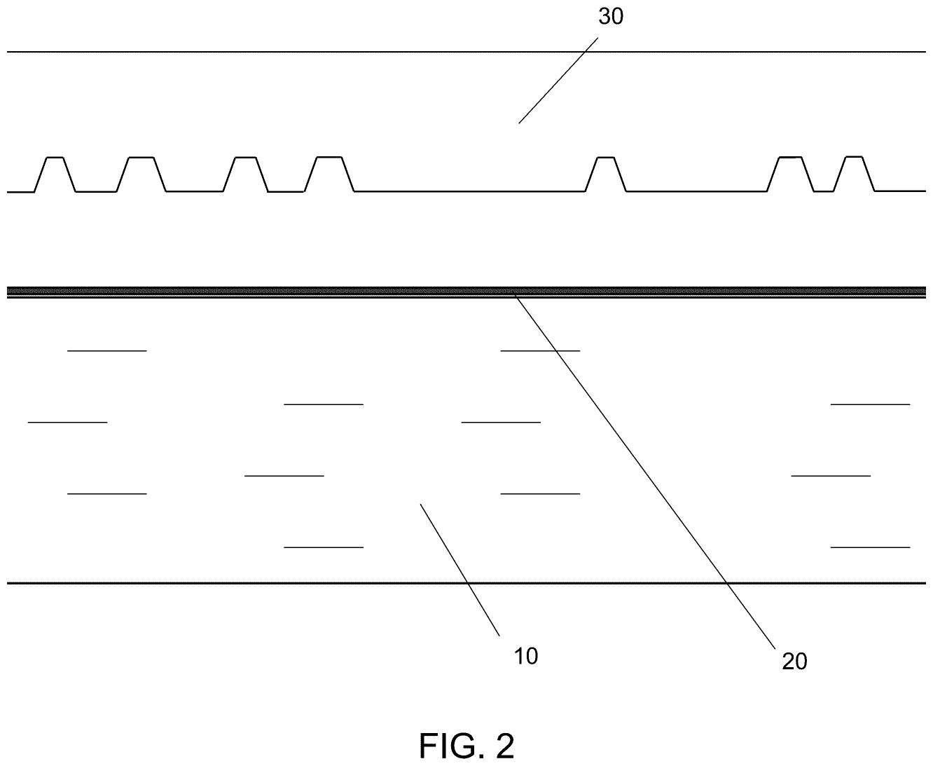

FIG. 3 shows a cutaway view after pressing of the strand mat with paper overlay to produce the panel, where the portion of irregular pebbled stucco texture has been pressed therein.

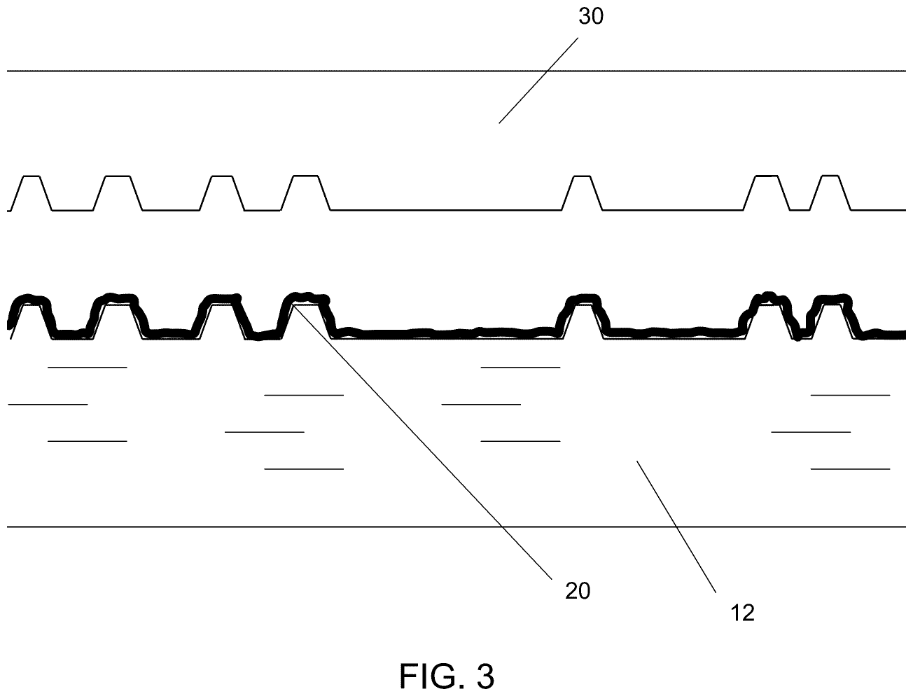

FIG. 4 shows a view of exemplary size ranges for the features of the irregular pebbled texture.

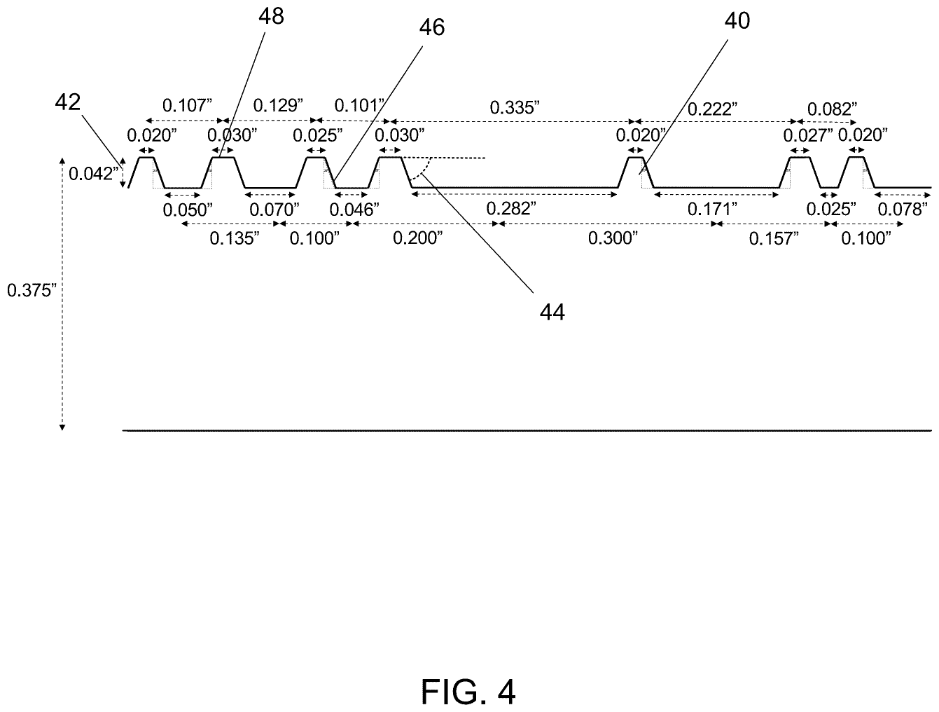

FIG. 5 shows a cutaway view of a portion of an acid-engraved plate with a portion of texture with variations in the depth and other dimensions of the texture features.

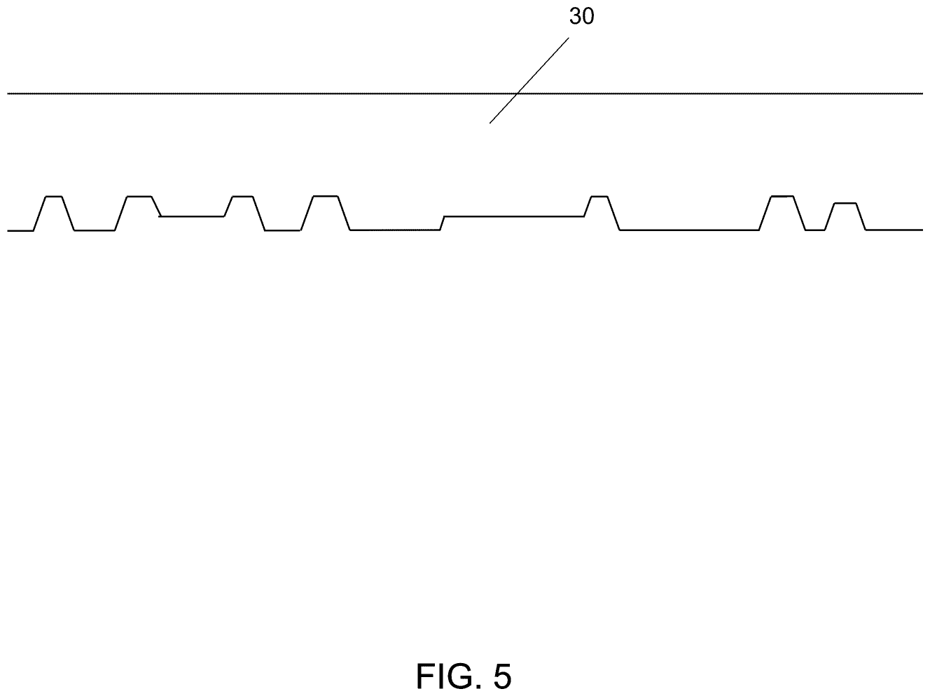

### DETAILED DESCRIPTION OF EMBODIMENTS OF THE INVENTION

In various exemplary embodiments, the present invention comprises an apparatus and method of producing strand siding boards and/or panels with a pebbled stucco texture 2. Traditional stucco siding is a cement-type mixture made of Portland cement, lime, sand, and water, is applied as a thing finish coat on the outer layer of residential and commercial buildings and structures. While popular in many areas, it generally is installed in layers and requires a more professional application, making it time-consuming and expensive.

The present invention thus provides engineered-wood siding panel, which can be a structural panel, with the aesthetic appearance of traditional stucco. This avoids the time and cost of traditional stucco siding.

In a method in accordance with an exemplary embodiment of the present invention, a multi-layer mat of wood strands 10 is formed on a production line. The strands are mixed or blended with a combination of one or more resins, waxes, and/or functional additives or chemicals (e.g., pesticides, fire-resistant chemicals, and the like). A paper overlay 20 is applied to the upper surface of the mat. The mat is then subjected to heat and pressure in a press (which may be a multi-layer press) to consolidate the mat into a board. The press comprises one or more engraved or cast metal top plates 30, which have been engraved or cast with a stucco impression.

The stucco impression may be initiated from a digital scan of one or more actual stucco siding examples. The digital scan information then may be combined and/or modified, such as increasing the scale (as the underlying texture of the engineered wood strands and flakes will show through, i.e., “telegraphing”, if the scale of the texture is too small) and/or depth of the stucco features 40 to increase the overall scale and visibility of the stucco texture on the panel product.

Telegraphing is a condition where the texture of a multi-layer composite wood or manufactured-wood product is revealed or shown through a smoother outer covering surface, typically after exposure to water or high humidity. Panels of the type described herein, such as OSB-based panels or substrates, have rough surfaces on formation, and these surfaces become even more irregular upon exposure to moisture. The moisture causes uneven swelling of the strands or wafers which make up the panel structure. The application of paper overlays, such as resin-impregnated paper overlays, can be adhered to the surface of the lignocellulosic products during the pressing step in an effort to provide finishable surface, but while such surfaces may be smooth immediately after formation, the paper overlays will telegraph the wafter or strand shape when the product is exposed to water and/or high humidity. Various prior art methods attempting to address telegraphing typically still telegraph to a visible extent, or require higher-cost multiple handling steps or components. The advantage of the present invention is that the stucco pattern described herein can be easily applied to the paper overlay during the pressing process itself through means of the press plate, as described above, thereby employing a lower cost, integrated method which is typically performed as a one-step process.

The thickness of the paper overlay is generally about 0.008″, and thus is rather thin compared to the underlying manufactured-wood substrate. To provide a visible stucco texture without causing holes or tears in the overlay and of suitable size to reduce or eliminate the showing of telegraphing on the outer surface, it is critical that the maximum depth 42 of any portion of the pattern (from highest to lowest points or levels of the features) should not be more than 0.042″. Further, in order to obtain at least a minimum of texture transfer and have visibility on the finished product, the depth of the pattern should not be less than approximately 0.015″.

Further, some stucco patterns have sharp corners or near vertical angles downward from the highest or topmost elements, which would cause deep holes and tears in the overlay and substrate of the finished product. Accordingly, it is critical that there is a maximum angle of no more than 70 degrees 44 (from the horizontal; 20 degrees from the vertical) in the drop or downward direction of a shoulder 46 of the feature from the horizontal top or flat element 48.

After pressing, the resulting blank or board with a stucco pattern is subject to further processing, including, but not limited to, cutting into several boards or panels, sealing of edges, painting, and the like.

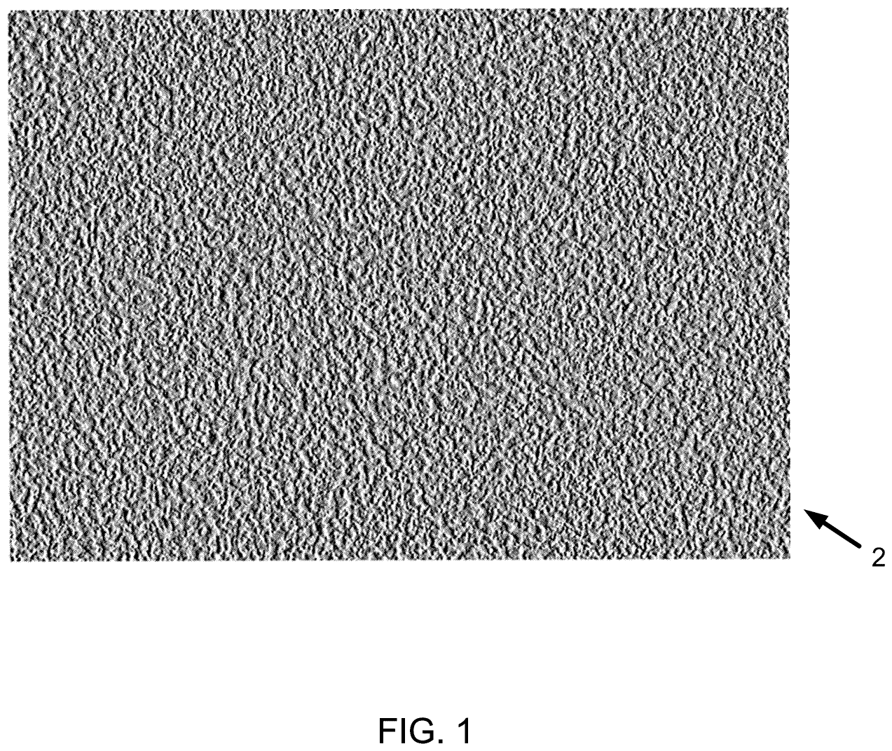

Accordingly, the present invention provides a structural panel with a highly-desired stucco texture with superior durability that is lightweight and easier to install than traditional stucco. Surprisingly, the stucco texture also has been found to wholly or partially eliminate telegraphing of the underlying strands and flakes in the underlying panel. In one exemplary embodiment, the stucco texture shown in FIG. 1 completely eliminates telegraphing on the surface of the panel, thereby solving a long existing problem in the manufactured wood industry.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A panel product, comprising:
a manufactured-wood substrate comprising multiple layers of oriented wood strands, said substrate with a length, a width, a depth, and a top face; and
a paper overlay affixed to the top face and integrated with the substrate;
wherein the paper overlay and top face of the manufactured-wood substrate comprise an embossed pattern impressed thereon, said embossed pattern comprising an irregular pebbled texture with multiple high elements and multiple low elements, wherein the vertical distance between the multiple high elements and the multiple low elements does not exceed 0.042″.

2. The panel product of claim 1, wherein the embossed pattern emulates a pebbled stucco texture.

3. The panel product of claim 1, wherein the embossed pattern varies randomly in the x (width), y (length), and z (depth) directions.

4. The panel product of claim 1, wherein each of the multiple high elements comprise a horizontal top with one or more edges, with one or more shoulders extending outward and downward at an angle from said edges, wherein said angle is not orthogonal to the horizontal top.

5. The panel product of claim 3, wherein said angle does not exceed 70 degrees from the horizontal.

6. The panel product of claim 3, wherein said angle is not less than 20 degrees from the vertical.

7. The panel product of claim 4, wherein each of the multiple low elements comprise a horizontal floor with one or more edges.

8. The panel product of claim 1, wherein the distance between the multiple high elements and the multiple low elements is not less than 0.005″.

9. The panel product of claim 7, further comprising a plurality of horizontal middle elements with one or more edges, each disposed at a depth between the horizontal tops of the multiple high elements and the horizontal floors of the multiple low elements.

10. The panel product of claim 9, wherein at least some of the horizontal middle elements are connected to one or more adjacent high elements, low elements, and/or middle elements by one or more shoulders extending between respective edges.

11. The panel product of claim 1, wherein the embossed pattern hides any underlying telegraphing in the strands of the substrate.

12. The panel product of claim 1, wherein the embossed pattern does not transmit any underlying telegraphing in the strands of the substrate.

13. The panel product of claim 1, wherein the embossed pattern does not show any underlying telegraphing in the strands of the substrate.
